(19) United States
(12) Patent Application Publication
(10) Pub. No.: US 2004/0026029 A1
(43) Pub. Date: Feb. 12, 2004

(54) Heat sealing apparatus for packacing machinery

(76) Inventors: Simon Charles Martin, Coventry (GB); David Robert Seaward, Coventry (GB); Peter John Whitlock, Coventry (GB)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/362,232

(22) PCT Filed: Aug. 17, 2001
(86) PCT No.: PCT/GB01/03724

(30) Foreign Application Priority Data
Aug. 23, 2000 (GB) 0020840.5

(51) Int. Cl. B32B 31/00

(52) U.S. Cl. 156/275.1; 156/499; 156/497

(57) ABSTRACT

Heat sealing apparatus for packaging machinery and particularly suitable for form, fill and seal packaging machinery. The heat sealing apparatus is for forming a continuous lengthways extending seal (29) on a web (18) of packaging material to be fed past it. The apparatus comprises a nozzle (50) connectable to a hot gas producer (62) which produces a flow of hot gas having a substantially constant temperature. The nozzle is mounted on a carrier (52) which is connected with a servo motor drive (56). The servo motor is controlled by a control system (48) so that in use it moves the nozzle relative to the web in accordance with variations in web feed velocity such that the flow of hot gas from the nozzle can apply a substantially constant heat to the web to form the seal (29). The apparatus allows a hot air producer which outputs hot air at a constant temperature and volume flow rate to apply a constant heat along the seal area despite variations in the web feed speed.

The invention relates to heat sealing apparatus for packaging machinery and particularly, but not exclusively, to heat sealing apparatus for vertical, form, fill and seal (VFFS) packaging machinery.

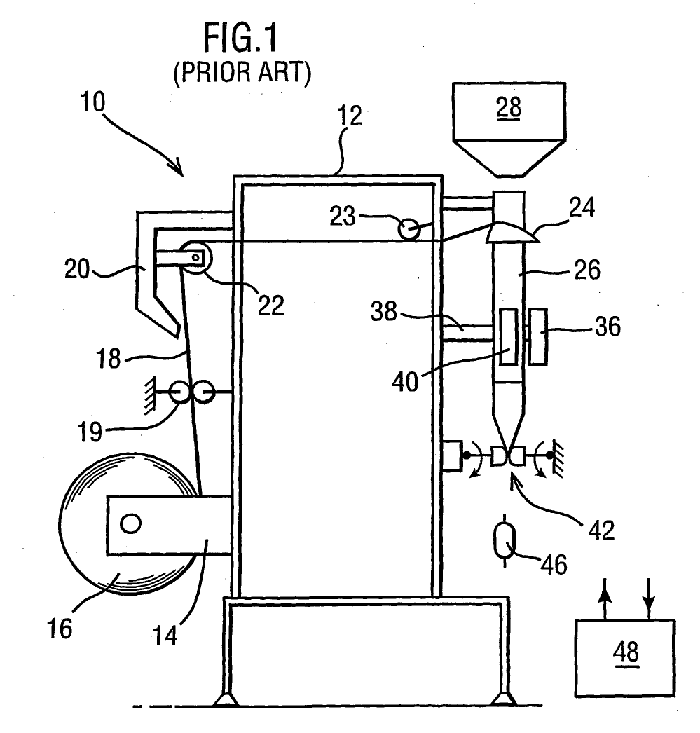

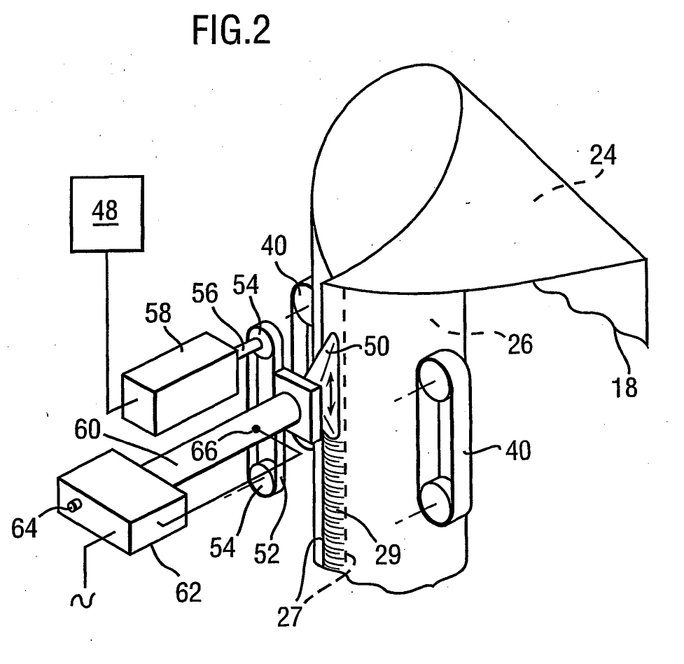

VFFS machines usually produce filled and sealed bags from a flexible packaging material, although they can be used to produce empty bags to be filled and sealed subsequently. A known configuration of VFFS packaging machine is shown in FIG. 1. In this machine, a web 18 of flexible packaging material is fed over a forming shoulder 24 which causes it to form into a tube wrapped about a vertically oriented filling pipe 26. The edges 27 of the web (FIG. 2) are sealed together in the longitudinal direction of the tube by a heat sealing device 36 to produce a backseal 29. The backseal is a continuous seal extending along the length of the tubular web and is so-called because it can be found at the back of the completed bag. Subsequently, successive transverse seals are made at bag length intervals by opposed transverse sealing jaws 42. The sealing jaws 42 typically carry a knife arrangement (not shown), which cuts through the area of the transverse seal so that each transverse seal provides a top seal for a completed bag 46 and a bottom seal for the bag immediately upstream thereof. Product from a product weigher 28 is fed down the filling tube 26 in synchronicity with the sealing jaws so that each package contains a required amount of product.

Typically the heat sealing device 36 comprises heated wheels or belts which engage the tubular web and apply heat to the web as it is fed down the forming tube past the backseal device.

In order to obtain a good, strong, consistent seal, it is necessary to apply heat evenly to the web. This can be more critical in the case of some materials, for example polythene, than for others. Heated wheels and belts have a certain mass and thus a certain degree of thermal inertia, which makes it difficult, if not impossible, to change their temperature during the bag forming cycle. Thus, where the web feed speed varies during a bag forming cycle, it is not possible to correspondingly vary the amount of heat applied so as to provide even heating along the backseal. The result can be burn-through of the material at some points where the web is running relatively slowly, and/or no-seal at others where insufficient heat is applied due to decreased sealing time when the web is running fast.

There have been proposals to form the backseal using a hot air backseal device. Hot air backseal devices blow air over a heater and direct the heated air onto the backseal area by means of a nozzle. The amount of heat applied has typically been varied to take account of different web speeds by varying the energy input to the heater, varying the airflow over the heater or selectively venting the heated air away from the seal area. Known hot air backseal devices are disclosed in U.S. Pat. No. 5,466,326 and WO98/40202.

The discussion of the background to the invention herein has been provided simply to explain the context of the invention and it not to be taken as an admission that any of the material referred to was known or part of the common general knowledge in Australia or elsewhere in the world as at the priority date of any of the claims.

The invention provides heat sealing apparatus for forming a continuous lengthways extending seal on a web of packaging material to be fed past said apparatus, said apparatus comprising a nozzle connectable to a hot gas producer which produces a flow of hot gas having a substantially constant temperature and mass flow rate, a carrier for said nozzle and a drive for said carrier, the arrangement being such that in use said nozzle can be controllably moved relative to said web in accordance with variations in web feed velocity such that said flow of hot gas from said nozzle can apply a substantially constant heat to said web to form said lengthways extending seal.

The invention includes form, fill and seal packaging apparatus, said apparatus including a web feeder for feeding a web of packaging material over a flow former, said web having lengthways extending edges and said flow former being arranged to cause said web to adopt a generally tubular configuration wherein said edges are disposed in generally adjacent relationship, and a heat sealing device for forming a continuous -seal adjacent said edges by which said edges are held in said adjacent relationship, said heat sealing device comprising a nozzle connected with a hot air producer for directing a flow of hot gas at said web, a carrier for said nozzle and a drive for said carrier, said drive being arranged to controllably move said nozzle relative to the web in accordance with variations in web feed velocity such that said flow of hot gas from said nozzle applies a substantially constant heat to said web to form said continuous seal.

The invention also includes a method of forming a continuous seal along a moving web of packaging material, said method including moving said web at a cyclically varying velocity, directing a flow of hot gas at said web, said flow having a substantially constant temperature and volume flow rate, and cyclically moving said flow relative to said web along a region to be sealed such that a substantially constant heat is applied to said web to form said seal.

The invention also includes form, fill and seal packaging apparatus, said apparatus comprising means for feeding a web of heat sealable packaging material, forming means arranged to cause said web to adopt a tubular configuration in which opposed lengthways extending edges of the web are brought into a juxtaposed relationship and heat sealing means for forming a continuous seal in the region of said edges, said heat sealing means comprising means for directing a flow of hot gas at said web to form said seal and being arranged to move said flow relative to said web such that a substantially constant heat is applied to the web.

In order that the invention may be well understood, an embodiment thereof, which is given by way of example only, will now be described with reference to the drawings, in which:

FIG. 1 is a schematic side elevation of a vertical, form, fill and seal packaging machine;

FIG. 2 is a perspective view of a hot gas backseal device for the machine shown in FIG. 1;

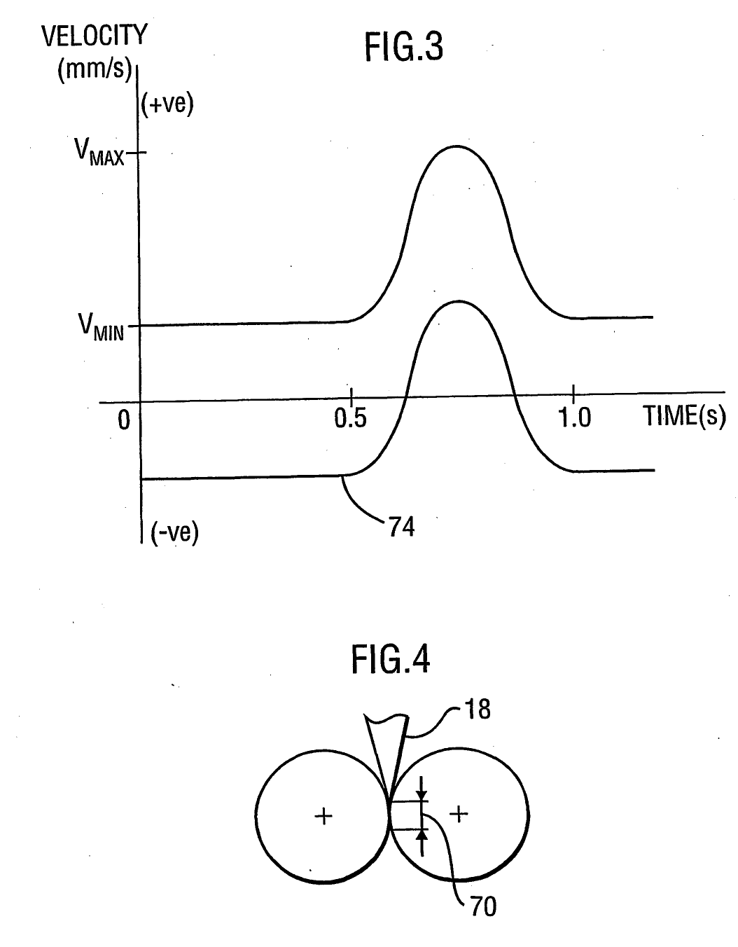

FIG. 3 is a graphical representation of features of a bag making cycle using the machine of FIGS. 1 and 2; and

FIG. 4 represents the motion of the transverse sealing jaws of the machine of FIG. 1.

FIG. 1 is a schematic side elevation of a VFFS machine 10 for making and filling bags. The machine comprises a frame 12 to the rear of which is fixed a mounting device 14. The mounting device 14 is arranged to receive a reel 16 of a packaging film such as polythene. The reel is rotatably supported by the mounting device so that the film, or web 18, can be drawn from the reel by a nip roller drive 19 which is driven by a servo motor (not shown).

The web 18 passes upwardly from the mounting device through the nip roller drive 19 to a first roller unit 20, also mounted at the rear of the frame. The roller unit 20 comprises one or more rollers (illustrated schematically as roller 22) around which the web is guided, and is arranged such that the web is directed towards the front of the frame 12 where it passes under a roller 23 before feeding onto a forming shoulder 24.

The forming shoulder 24 is carried on a cylindrical filling tube 26 which is supported on the front of the frame. A weigher or other control device 28 is mounted above the filling tube 26 and is arranged to drop predetermined amounts of product down into the filling tube.

The web passes over the forming shoulder 24 into an arcuate space between the filling tube 26 and the forming shoulder. The arrangement of the forming shoulder and filling tube is such as to cause the web to adopt a tubular configuration about the filling tube. Downstream of the forming shoulder, there is a heat sealing unit 36 which is positioned at the front of the machine and connected to the frame 12 by means of an L-shaped connecting arm 38, which is arranged to allow the sealing unit to be swung away from the filling tube when desired. The heat sealing unit will be described in more detail below with reference to FIGS. 2 to 4.

Two drive bands 40, or alternatively draw-off rollers, are arranged on opposite sides of the filling tube 26 to draw the web 18 downwardly towards opposed rotary sealing jaws 42. The sealing jaws are driven to rotate continuously by means of a servo motor (not shown) and are arranged to form transverse seals at bag length intervals. The sealing jaws 42 carry a knife arrangement (not shown) which cuts through the transverse seals thereby separating completed bags 46 from the web.

The bag making machine has a control system 48 which is arranged to provide suitable control signals for synchronising the operations carried out by various parts of the machine. The control system can be of any known type and may, for example, comprise a PLC.

Referring to FIG. 2, the heat sealing unit, or backseal device 36, includes a nozzle 50 positioned opposite and adjacent the filling tube 24. The arrangement is such that the edges 27 of the tubular web, which are to be joined to form a continuous backseal 29, pass between the nozzle and the filling tube as the web is fed downwardly towards the sealing jaws 42.

The nozzle 50 is carried on an endless band 52 which is supported by two pulleys 54. The pulleys 54 are mounted one above the other with their respective axes of rotation in parallel spaced apart relationship. One of the pulleys is connected to the output shaft 56 of a servo motor 58 and serves as a drive pulley for the band 52.

The servo motor 58 receives control signals from the PLC 48 which cause it to rotate the output shaft 56 back and forth thereby reciprocating the nozzle in the lengthways direction of the filling tube. The arrangement of the band 52 and the pulleys 54 is such that the nozzle remains at a fixed distance from the filling tube 26 as it reciprocates.

The nozzle is connected by a pipe 60 to a hot air blower 62. In the embodiment, the pipe and blower are carried with the nozzle by the endless band 52. Alternatively, the blower may be mounted on the machine frame 12 and connected with the nozzle by means of suitable flexible ducting.

The hot air blower includes an electrical resistance heater together with a fan which blows air over the heater. The hot air blower includes a poteniometer 64 by which the current supplied to the heater can be controlled to set a desired output temperature. A temperature sensor 66 is mounted in an aperture provided in the pipe 60 to sense the air output temperature and provides a signal to the control circuitry of the blower which is used to switch the heater to maintain the desired temperature. In addition to, or as an alternative to the poteniometer, means may be provided for controlling the mass air flow through the blower. These means could take the form of a speed control for the fan or a means for venting the airflow to the heater.

The hot air blower may in principle be any commercially available product and the inventors have successfully tested prototype apparatus using a Leister Hot-Air Tool 3000, Model 8D1.

In use, the operator of the machine programmes the desired operating parameters into the PLC 48 and sets the hot air blower 52 to produce heated air at a desired flow rate and output temperature for the sealing operation. The operating parameters to be entered into the PLC will include the operating speed of the machine in bags per minute (bpm), the bag length and the seal time. The seal time, or sealing interval, is the time required for the transverse sealing jaws to produce a reliable transverse seal 42. The seal time will at least in part be dependent on the thickness of the web 18 and the type of material from which the web is made. The operator will additionally enter the sealing length 70 (FIG. 4), unless this information is stored in the PLC. The sealing length is a function 5 of the geometry of the sealing jaws and is the length of the web travel during which the sealing jaws will engage the web. From this information the PLC generates a control sequence, referred to herein as a cam profile, which will govern the motion of respective servo motors which drive the transverse sealing jaws and the nip rollers 19.

An example of a part of the cam profile produced by the PLC is shown in FIG. 3, which is a plot of velocity in mm/s and time in seconds. In the example, bags having a length of 300 mm are to be produced at the rate of 60 bpm so that the cycle time for producing each bag is 1 second. The sealing interval for the sealing jaws is 0.5 seconds. Based on the desired sealing time and the sealing length 70, the PLC determines the velocity of the web feed during the sealing interval. In the example the sealing length is 60 mm and therefore the web feed velocity during the sealing interval would be 120 mm/s, which is indicated as V_{MIN} in FIG. 3.

Since 60 mm of the 300 mm bag length is fed during sealing interval, the other 240 mm must be fed through in the remaining 0.5 seconds of the bag making cycle. In order to achieve this, the web is accelerated rapidly to a maximum velocity (shown as V_{MAX} in FIG. 3) and then decelerated to V_{MIN} ready to commence the next bag making cycle. In the example, V_{MAX} is 840 mm/s.

From the foregoing description it will be appreciated that during a bag making cycle, the web travels relatively slowly at a constant rate during the sealing interval and at a much faster rate, which typically varies substantially continuously, during the remainder of the cycle.

The hot air blower delivers air at a substantially continuous rate and temperature and in order to ensure that a substantially continuous amount of heat is applied to the web as the web speed varies, the servo motor 56 is actuated to cause the nozzle to reciprocate in synchronisation with the web feed cam profile. In more detail, the PLC determines a velocity offset, which is the average velocity of the web over a bag cycle. The PLC provides the necessary control signals for the servo motor such that the relative velocity between the nozzle and the web remains substantially constant, matching the velocity offset throughout the bag making cycle.

The velocity offset (average velocity of the web) in the example given is 300 mm/s and thus the servo motor is driven to maintain a relative velocity of 300 mm/s between the nozzle and the web. The velocity profile of the nozzle is shown in FIG. 3 by curve 74; a negative velocity indicating movement in the opposite direction to that of the web and a positive velocity indicating movement in the same direction as the web. Referring to FIG. 3, it will be seen that during the sealing interval the nozzle moves upwards in the opposite direction to the web at a velocity of 180 mm/s, thereby maintaining a relative velocity of 300 mm/s between the web and the nozzle. After 0.5 seconds, the nozzle starts to accelerate maintaining a velocity offset of 300 mm/s and reaching a peak velocity of 540 mm/s when the web speed reaches V_{MAX}.

By driving the nozzle 50 to maintain the relative velocity of the nozzle and web at the average web velocity, it is possible to ensure that each unit area of web which is a part of the backseal 29 takes the same amount of time to pass the nozzle and thus since the heat output by the hot air blower is substantially constant, a constant heat is applied along the length of the backseal. Accordingly, provided the hot air blower is set to direct the correct amount of heat at the web, the seal produced should be of a consistent quality along its length despite significant variations in the web speed during each bag making cycle.

It will be understood that by moving the nozzle in synchronisation with the web velocity as illustrated in FIG. 3, the effect is of having a fixed nozzle, with the web moving past at a constant velocity.

The machine 10 incorporating a hot air backseal device 36 has been tested by the applicant and found to produce good quality, consistent backseals even when sealing polythene in a bag making cycle having a 10:1 velocity ratio on the web.

It will be understood that many modifications may be made to the web feed arrangement shown in FIG. 1 and that the machine may incorporate any conventional web feed arrangement. For example, in place of the nip rollers 19, the reel may be driven in cooperation with the drive bands 40 and tensioning rollers and dancer arm rollers may be incorporated as desired.

In FIG. 1, the machine is shown having one set of transverse sealing jaws. The machine may have more than one set of jaws as is known in the art and in place of the rotary jaws indicated, the machine may be provided with any form of jaw arrangement used in continuous motion VFFS machines. For example, the machine may have two sealing jaws which move along opposed D-paths or substantially rectangular paths. Such arrangements will be recognised by those skilled in the art and accordingly, will not be described in detail herein.

It will be appreciated that the drive for the hot air backseal device is not limited to a servo motor. In principle any form of drive which permits the nozzle to be controllably moved could be used. An example of an alternative drive is a stepper motor.

It will be understood that many forms of control device may be provided for governing the motion of the various moving parts in the machine. For example, in the embodiment, the nip roller drive 19, sealing jaws 42 and endless band 52 are each driven by a respective servo motor. The PLC provides control signals for the servo motors so that the motion of the various parts is synchronised. Each servo motor may have its own motion controller which is fed with control signals from the PLC. Alternatively, the PLC may be suitably equipped to incorporate the motion control function, in which case it would communicate directly with the servo motors. These aspects of the control of the machine will be readily understood by those skilled in the art and thus a comprehensive description of the various alternatives and modifications to the control systems and hardware for the machine and in particular the backseal device will not be provided herein.

It is to be understood that whilst the hot air backseal device 36 has been illustrated and described in conjunction with VFFS machinery, it can equally be used in conjunction with horizontal form, fill and seal (HFFS) machinery. Since the application of the device to HFFS machinery will be readily apparent to those skilled in the art, no specific description of such application is provided herein.

1. Heat sealing apparatus for forming a continuous lengthways extending seal on a web of packaging material to be fed past said apparatus, said apparatus comprising a nozzle connectable to a hot gas producer which produces a flow of hot gas having a substantially constant temperature and mass flow rate, a carrier for said nozzle and a drive for said carrier, the arrangement being such that in use said nozzle can be controllably moved relative to said web in accordance with variations in web feed velocity such that said flow of hot gas from said nozzle can apply a substantially constant heat to said web to form said lengthways extending seal.

2. Apparatus as claimed in claim 1, further comprising a hot air producer connected to said nozzle and carried by said carrier.

3. Form, fill and seal packaging apparatus, said apparatus including a web feeder for feeding a web of packaging material over a flow former, said web having lengthways extending edges and said flow former being arranged to cause said web to adopt a generally tubular configuration wherein said edges are disposed in generally adjacent relationship, and a heat sealing device for forming a continuous seal adjacent said edges by which said edges are held in said adjacent relationship, said heat sealing device comprising a nozzle connected with a hot air producer for directing a flow of hot gas at said web, a carrier for said nozzle and a drive for said carrier, said drive being arranged to controllably move said nozzle relative to the web in accordance with variations in web feed velocity such that said flow of hot gas from said nozzle applies a substantially constant heat to said web to form said continuous seal.

4. Apparatus as claimed in claim 3, wherein said web feeder feeds said web substantially continuously at cyclically varying velocities and said nozzle is moved such that there is a predetermined relative velocity between said nozzle and said web.

5. Apparatus as claimed in claim 4, wherein said relative velocity is substantially constant.

6. Apparatus as claimed in claim 3, 4 or 5, wherein said drive is arranged to cause said nozzle to reciprocate generally parallel to said adjacently disposed edges.

7. Apparatus as claimed in any one of claims 3 to 6, wherein said hot air producer is carried by said carrier.

8. Apparatus as claimed in any one of claims 3 to 7, wherein said drive includes a servo motor.

9. Apparatus as claimed in any one of claims 3 to 8, comprising a control device for said drive, said control device being arranged to provide a control signal for said drive, said control signal being a function of said web feed velocity.

10. Apparatus as claimed in claim 9, wherein control device is programmable.

11. Apparatus as claimed in claim 9 or 10, wherein said control device provides a control signal such that a relative velocity between said web and said nozzle substantially equal to an average velocity of said web, is maintained.

12. A method of forming a continuous seal along a moving web of packaging material, said method including moving said web at a cyclically varying velocity, directing a flow of hot gas at said web, said flow having a substantially constant temperature and volume flow rate, and cyclically moving said flow relative to said web along a region to be sealed such that a substantially constant heat is applied to said web to form said seal.

13. A method as claimed in claim 12, comprising reciprocating said flow of hot gas in a lengthways direction of said seal.

14. A method as claimed in claim 12 or 13, comprising determining an average velocity of said web and moving said flow relative to said web so as to maintain a relative velocity between said web and said flow which relative velocity is substantially equal to said average velocity.

15. Form fill and seal packaging apparatus, said apparatus comprising means for feeding a web of heat sealable packaging material, forming means arranged to cause said web to adopt a tubular configuration in which opposed lengthways extending edges of the web are brought into a juxtaposed relationship and heat sealing means for forming a continuous seal in the region of said edges, said heat sealing means comprising means for directing a flow of hot gas at said web to form said seal and being arranged to move said flow relative to said web such that a substantially constant heat is applied to the web.

16. Apparatus as claimed in claim 15, wherein said heat sealing means comprises outlet means connected with hot air producing means and mounted on transport means.

17. Apparatus as claimed in claim 16, wherein said forming means includes pipe means around which said web is wrapped to cause it to adopt said tubular configuration, said transport means being arranged to reciprocate said outlet means parallel to a longitudinal axis of said pipe means.

18. Apparatus as claimed in claim 16 or 17, wherein said transport means moves said outlet means such that a relative velocity substantially equal to an average velocity of said web is maintained between said web and said outlet means.

19. Apparatus as claimed in claim 18, comprising a programmable control means for said transport means.
